(19) United States
(12) Patent Application Publication
(10) Pub. No.: US 2019/0296667 A1
(43) Pub. Date: Sep. 26, 2019

(54) CONTROL DEVICE FOR MOTOR, ROBOT, AND CONTROL METHOD FOR MOTOR

(71) Applicant: Nidec Corporation, Kyoto (JP)

(72) Inventors: Zhaoqin GUO, Singapore (SG); Jianyi WANG, Singapore (SG); Shijun YAN, Singapore (SG)

(21) Appl. No.: 16/299,192

(22) Filed: Mar. 12, 2019

(30) Foreign Application Priority Data
Mar. 26, 2018 (JP) 2018-057854

(51) Int. Cl. H02P 6/15; B25J 9/12

(52) U.S. Cl. CPC H02P 6/153; B25J 9/126

(57) ABSTRACT

A reference determiner of a control device for a motor determines, at a predetermined period, a reference rotation angle of the motor as a command value to rotate the motor. When an actual rotation angle of the motor is delayed behind an immediately preceding reference rotation angle determined by the reference determiner and a delay amount is smaller than a predetermined threshold, the reference determiner determines a present reference rotation angle by adding an angle increment corresponding to rotating speed of the motor to the immediately preceding reference rotation angle, and, when the actual rotation angle is delayed behind the immediately preceding reference rotation angle and the delay amount is larger than the threshold, the reference determiner determines the immediately preceding reference rotation angle as the present reference rotation angle.

### CROSS REFERENCE TO RELATED APPLICATIONS

This application claims the benefit of priority to Japanese Patent Application No. 2018-057854 filed on Mar. 26, 2018. The entire contents of this application are hereby incorporated herein by reference.

### BACKGROUND OF THE INVENTION

### 1. Field of the Invention

The present disclosure relates to a control device for a motor, a robot, and a control method for a motor.

### 2. Description of the Related Art

For example, as a control method for a motor incorporated in a mobile robot or an articulated robot, it is known to control torque, a rotation angle, rotating speed, or a jerk (acceleration) of the motor according to an operation reference profile. The operation reference profile specifies a change over time of the torque, the rotation angle, the rotating speed, or the jerk of the motor. The operation reference profile is designed in advance based on a target rotation angle, performance of the motor (for example, achievable maximum rotation acceleration, achievable maximum rotation deceleration, and achievable maximum rotating speed), and a load applied to the motor. In general, a triangular or trapezoidal operation reference profile concerning a speed change and an operation reference profile of an S-shaped curve concerning an angle change are known.

For design of an appropriate operation reference profile, it is desirable to not only know the performance of the motor but also predict a load applied to the motor. This is because the operation of the motor is limited according to the load.

However, it is sometimes difficult and time-consuming to accurately predict a load. Disturbance could occur or a load could change during the operation of the motor. A reason of the disturbance may be, for example, an object driven by the motor collides with an obstacle. A reason for the change in the load may be, for example, the load applied to the motor changes when a posture of an arm changes. It is more difficult to predict the disturbance and the change in the load. Therefore, if an operation reference designed in advance assuming a fixed operation condition is used, an actual position cannot follow a reference position. As a result, a large difference could occur between the reference position and the actual position. As a result, deterioration in control performance of a system such as a large overshoot, a long setting time, and long duration of saturation of a driving signal of the motor could occur.

Further, if disturbance or a change in a load occurs during use of the operation reference profile designed in advance, sudden acceleration or deceleration of the motor is sometimes necessary. As a result, the life of components of the motor or related components such as a gear is likely to decrease.

In the control of the motor, the motor desirably smoothly operates. It is desirable to minimize an overshoot, reduce a setting time to a target position, and reduce a saturation time of a driving signal. These targets should be achieved even if disturbance or a change in a load occurs.

In an existing technique, inertia and a coefficient of friction of a motor are estimated during the operation of the motor and control parameters of the motor are dynamically adjusted based on the estimation. However, the technique increases a load of computation and does not contribute to a reduction in an overshoot and a reduction in a setting time. Robustness against disturbance and a change in a load is weak.

In another existing technique, duration of segments (stages) in an operation profile is calculated, the duration is corrected, and an operation reference is recalculated using the corrected duration. However, in the existing technique, a load of computation is excessively large and robustness against disturbance and a change in a load is weak.

### SUMMARY OF THE INVENTION

A control device for a motor according to a certain aspect of the present disclosure includes a reference determiner to acquire an actual rotation angle of the motor at a predetermined period and determine a reference rotation angle of the motor at the predetermined period as a command value to rotate the motor. When the actual rotation angle of the motor is delayed behind an immediately preceding reference rotation angle determined by the reference determiner and a delay amount is smaller than a predetermined threshold, the reference determiner determines a present reference rotation angle by adding an angle increment corresponding to rotating speed of the motor to the immediately preceding reference rotation angle. When the actual rotation angle is delayed behind the immediately preceding reference rotation angle and the delay amount is larger than the threshold, the reference determiner determines the immediately preceding reference rotation angle as the present reference rotation angle.

A robot according to a certain aspect of the present disclosure includes at least one motor, a control device accompanying the at least one motor, and a machine element driven by the at least one motor.

A control method for a motor according to a certain aspect of the present disclosure includes acquiring an actual rotation angle of the motor at a predetermined period, and determining a reference rotation angle of the motor at the predetermined period as a command value to rotate the motor. In the determining the reference rotation angle, when the actual rotation angle of the motor is delayed behind an already determined immediately preceding reference rotation angle and a delay amount is smaller than a predetermined threshold, a present reference rotation angle is determined by adding an angle increment corresponding to rotating speed of the motor to the immediately preceding reference rotation angle. When the actual rotation angle is delayed behind the immediately preceding reference rotation angle and the delay amount is larger than the threshold, the immediately preceding reference rotation angle is determined as the present reference rotation angle.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a block diagram showing a control device for a motor according to an example embodiment of the present disclosure.

FIG. 2 is a flowchart showing determination processing for a reference rotation angle according to an example embodiment of the present disclosure.

FIG. 3 is a flowchart showing determination processing for a reference angle position according to an example embodiment of the present disclosure.

### DETAILED DESCRIPTION OF THE PREFERRED EMBODIMENTS

Example embodiments of the present disclosure is explained below with reference to the drawings.

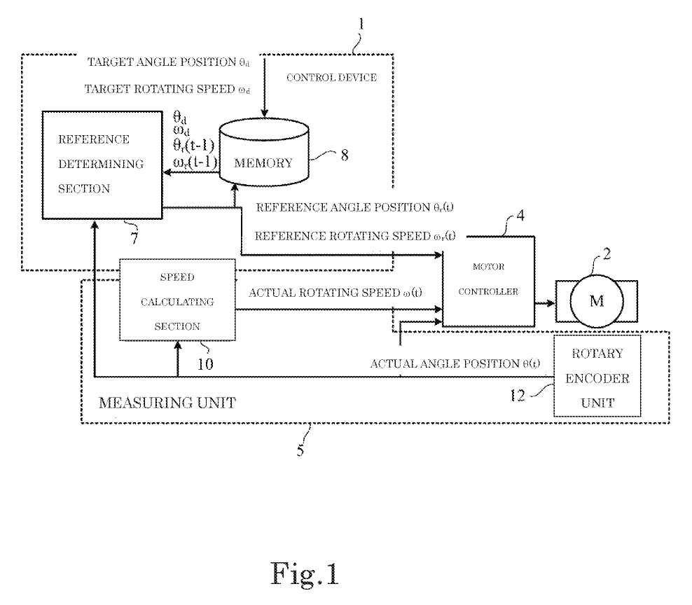

FIG. 1 is a block diagram showing a control device 1 for a motor according to the present example embodiment of the present disclosure. The control device 1 according to this embodiment is provided in a mobile robot in order to control a motor 2 that rotates a wheel of the mobile robot. The control device 1 gives command values to a motor controller 4 that drives the motor 2. The command values are a reference angle position (a reference rotation angle) θᵣ to which the motor 2 should be rotated and reference rotating speed ωᵣ at which the motor 2 should be rotated.

The motor controller 4 is a combination of a driving circuit and a processor. The motor controller 4 supplies a driving signal for controlling the motor 2 to the motor 2 such that the motor 2 rotates to the reference angle position θᵣ given from the control device 1 at the reference rotating speed ωᵣ given from the control device 1.

The control device 1 includes a reference determining section 7 and a memory 8. The reference determining section 7 is a processor. The reference determining section 7 operates by reading out and executing a computer program stored in a recording medium (e.g., a memory 8). Therefore, the computer program (a program code) read out from the recording medium realizes functions of the embodiment. The recording medium having the computer program recorded therein can configure the present disclosure.

Various parameters are stored in the memory 8 in order to control the motor 2. The various parameters include a target angle position θ_{d} to which the motor 2 should be finally rotated and target rotating speed ω_{d} at which the motor 2 should be rotated. The various parameters also include the reference angle position θᵣ and the reference rotating speed ωᵣ determined by the reference determining section 7.

The reference determining section 7 determines the reference angle position θᵣ and the reference rotating speed ωᵣ given to the motor controller 4. In order to determine a present reference angle position θᵣ(t), the reference determining section 7 acquires, that is, reads out, from the memory 8, an immediately preceding reference rotation angle θᵣ(t−1) determined by the reference determining section 7.

The reference determining section 7 periodically determines, based on the immediately preceding reference rotation angle θᵣ(t−1) determined by the reference determining section 7, at a predetermined period (a sampling period) T, the present reference rotation angle θᵣ(t) at which the motor 2 should be rotated. The reference determining section 7 instructs the motor controller 4 at a sampling period T to rotate the motor 2 to the determined present reference rotation angle θᵣ(t). Therefore, the reference rotation angle θᵣ determined by the reference determining section 7 is a command rotation angle serving as a command value for rotating the motor 2. The reference determining section 7 stores the determined present reference rotation angle θᵣ(t) in the memory 8.

The present reference rotation angle θᵣ(t) means the reference rotation angle θᵣ at a present sampling time t for controlling the motor 2. The immediately preceding reference rotation angle θᵣ(t−1) means the reference rotation angle θᵣ at an immediately preceding sampling time t−1 (a sampling time before the present sampling time t by the sampling period T). In the following explanation, a reference rotation angle is referred to as reference angle position.

In order to determine present reference rotating speed ωᵣ(t), the reference determining section 7 acquires, that is, reads out, from the memory 8, an immediately preceding reference rotating speed ωᵣ(t−1) determined by the reference determining section 7.

The reference determining section 7 determines, base on the immediately preceding rotating speed ωᵣ(t−1) of the motor 2 determined by the reference determining section 7, at the sampling period T, the present reference rotating speed ωᵣ(t) at which the motor 2 should be rotated. The reference determining section 7 periodically instructs the motor controller 4 at the sampling period T to rotate the motor 2 at the reference rotating speed ωᵣ(t). Therefore, the reference rotating speed ωᵣ determined by the reference determining section 7 is command rotating speed serving as a command value for rotating the motor 2. The reference determining section 7 stores the determined present reference rotating speed ωᵣ(t) in the memory 8.

The present reference rotating speed ωᵣ(t) means the reference rotating speed ωᵣ at the present sampling time t for controlling the motor 2. The immediately preceding reference rotating speed ωᵣ(t−1) means the reference rotating speed ωᵣ at an immediately preceding sampling time t−1 (a sampling time before the present sampling time t by the sampling period T).

The control device 1 cooperates with a measuring unit 5. The measuring unit 5 includes a speed calculating section 10 and a rotary encoder unit 12. The rotary encoder unit 12 measures an angle position of the motor 2. The rotary encoder unit 12 is disposed near the motor 2 or a wheel or on the inside of the motor 2. The rotary encoder unit 12 periodically supplies, at the sampling period T, an actual rotation angle θ to the motor controller 4, the reference determining section 7, and the speed calculating section 10 as an angle position signal representing an angle position of the motor 2. Therefore, the reference determining section 7 periodically acquires a present actual rotation angle θ(t) of the motor 2 at the sampling period T. The reference determining section 7 uses the present actual rotation angle θ(t) for determination of the reference angle position θᵣ(t) and the reference rotating speed ωᵣ(t). The present actual rotation angle θ(t) means actual rotation angle θ of the motor 2 at the present sampling time t. In the following explanation, an actual rotation angle is referred to as actual angle position.

The speed calculating section 10 periodically calculates, based on an angle position signal, at the sampling period T, the present actual rotating speed ω(t) of the motor 2 using a publicly-known method. Rotating speed ω is an estimated value, that is, a measured value. However, the rotating speed ω is referred to as actual rotating speed in order to distinguish the rotating speed ω from the reference rotating speed θᵣ. The speed calculating section 10 periodically supplies the present actual rotating speed ω(t) of the motor 2 to the motor controller 4 at the sampling period T. The present actual rotating speed ω(t) means the actual rotating speed ω of the motor 2 at the present sampling time t. The present actual rotation angle θ(t) is supplied to the motor controller 4 from the rotary encoder unit 12. The present actual rotating speed ω(t) is supplied to the motor controller 4 from the speed calculating section 10. The reference angle position ωᵣ(t) and the reference rotating speed ωᵣ(t) are supplied to the motor controller 4 from the reference determining section 7. The processor of the motor controller 4 generates a driving signal based on the present actual rotation angle θ(t), the present actual rotating speed ω(t), the reference angle position θᵣ(t), and the reference rotating speed ωᵣ(t) according to a predetermined algorism and supplies the driving signal to the driving circuit. As a result, the motor 2 rotates to the reference angle position θᵣ(t) at the reference rotating speed ωᵣ(t).

Parameters and variables used in this specification are explained.

θᵣ: A reference angle position

ωᵣ: Reference rotating speed

θ: An actual angle position

ω: Actual rotating speed

The reference angle position θᵣ, the reference rotating speed ωᵣ, the actual angle position θ, and the actual rotating speed ω are as explained above.

θ_{d}: A target angle position of the motor 2. The target angle position θ_{d} is an angle position to which the motor 2 should be finally rotated. The target angle position θ_{d} is input by an administrator of the control device 1 or generated by a not-shown system controller. The target angle position θ_{d} is stored in the memory 8. The reference determining section 7 reads out the target angle position θ_{d} from the memory 8 and uses the target angle position θ_{d} for determination of the present reference angle position θᵣ(t) and the present reference rotating speed ωᵣ(t).

ω_{d}: Target rotating speed of the motor 2. The target rotating speed ω_{d} is desired speed at which the motor 2 should be rotated. The target rotating speed ω_{d} is equal to or lower than rated maximum speed of the motor 2. The target rotating speed ω_{d} is input by the administrator of the control device 1 and stored in the memory 8. Alternatively, the target rotating speed ω_{d} may be a default value stored in the memory 8 in advance. The reference determining section 7 reads out the target rotating speed ω_{d} from the memory 8 and uses the target rotating speed ω_{d} for determination of the present reference rotating speed ωᵣ(t).

a₁: An acceleration coefficient. When the motor 2 is accelerated, a speed increment (a fixed positive value) is added to rotating speed of the motor 2. The speed increment is a value obtained by multiplying the acceleration coefficient a₁ by the sampling period T. The acceleration coefficient a₁ is a fixed positive value. The acceleration coefficient a₁ is input by the administrator of the control device 1 and stored in the memory 8. Alternatively, the acceleration coefficient a₁ may be a default value stored in the memory 8 in advance. The reference determining section 7 reads out the acceleration coefficient a₁ from the memory 8 and uses the acceleration coefficient a₁ for determination of the present reference rotating speed ωᵣ(t) when the motor 2 is accelerated.

a₂: A deceleration coefficient. When the motor 2 is decelerated, a speed decrement (a fixed positive value) is subtracted from rotating speed of the motor 2. The speed decrement is a value obtained by multiplying the deceleration coefficient a₂ by the sampling period T. The deceleration coefficient a₂ is a fixed positive value. The deceleration coefficient a₂ is input by the administrator of the control device 1 and stored in the memory 8. Alternatively, the deceleration coefficient a₂ may be a default value stored in the memory 8 in advance. The reference determining section 7 reads out the deceleration coefficient a₂ from the memory 8 and uses the deceleration coefficient a₂ for determination of the present reference rotating speed ωᵣ(t) when the motor 2 is decelerated.

θₑ: A position error. The position error θₑ is a difference between the immediately preceding reference angle position θᵣ(t−1) and the present actual angle position θ(t) and is defined as θₑ=θᵣ(t−1)−θ(t).

θₜₕ: A position delay threshold. The position delay threshold θₜₕ is a positive threshold compared with the position error θₑ by the reference determining section 7 when the present reference angle position θᵣ(t) is determined. The position delay threshold θₜₕ is input by the administrator of the control device 1 and stored in the memory 8. Alternatively, the position delay threshold θₜₕ may be a default value stored in the memory 8 in advance. The reference determining section 7 reads out the position delay threshold θₜₕ from the memory 8 and uses the position delay threshold θₜₕ when the present reference angle position θᵣ(t) is determined.

θ_{dec}: A deceleration start border angle. The deceleration start border angle θ_{dec} is a positive value. The deceleration start border angle θ_{dec} is input by the administrator of the control device 1 and stored in the memory 8. Alternatively, the deceleration start border angle θ_{dec} may be a default value stored in the memory 8 in advance.

ω_{low}: Low rotating speed. The low rotating speed ω_{low} is constant speed at which the motor 2 should be rotated near the target angle position ω_{d}. The low rotating speed ω_{low} is speed lower than the target rotating speed ω_{d}. For example, the low rotating speed ω_{low} is a quarter of the target rotating speed ω_{d}. The low rotating speed ω_{low} is input by the administrator of the control device 1 and stored in the memory 8. Alternatively, the low rotating speed ω_{low} may be a default value stored in the memory 8 in advance. The reference determining section 7 reads out the deceleration start border angle θ_{dec} and the low rotating speed ω_{low} from the memory 8 and, when a value obtained by subtracting the present actual angle position θ(t) from the target angle position θ_{d} is smaller than the deceleration start border angle θ_{dec}, reduces the reference rotating speed ωᵣ(t) to the low rotating speed ω_{low}. That is, when the present actual angle position θ(t) is equal to or smaller than the deceleration start border angle θ_{dec} before the target angle position θ_{d}, the reference determining section 7 reduces the reference rotating speed ωᵣ(t) to the low rotating speed ω_{low}.

T: A sampling period. The sampling period T is, for example, 2 ms. The reference determining section 7 acquires the present actual angle position θ(t) of the motor 2 at the sampling period T, generates the present reference angle position θᵣ(t) at the sampling period T, and periodically determines the present reference rotating speed ωᵣ(t) at the sampling period T.

A control method for the motor 2 according to the embodiment is explained below. In the following explanation, it is assumed that the motor 2 is rotated in only one direction. However, the present disclosure can also be applied in order to rotate the motor 2 in the opposite direction. In the following explanation, an initial actual angle position θ and initial actual rotating speed ω are assumed to be zero. An initial reference angle position θᵣ and initial reference rotating speed ωᵣ are zero. However, the present disclosure can also be applied to any initial position and any initial rotating speed.

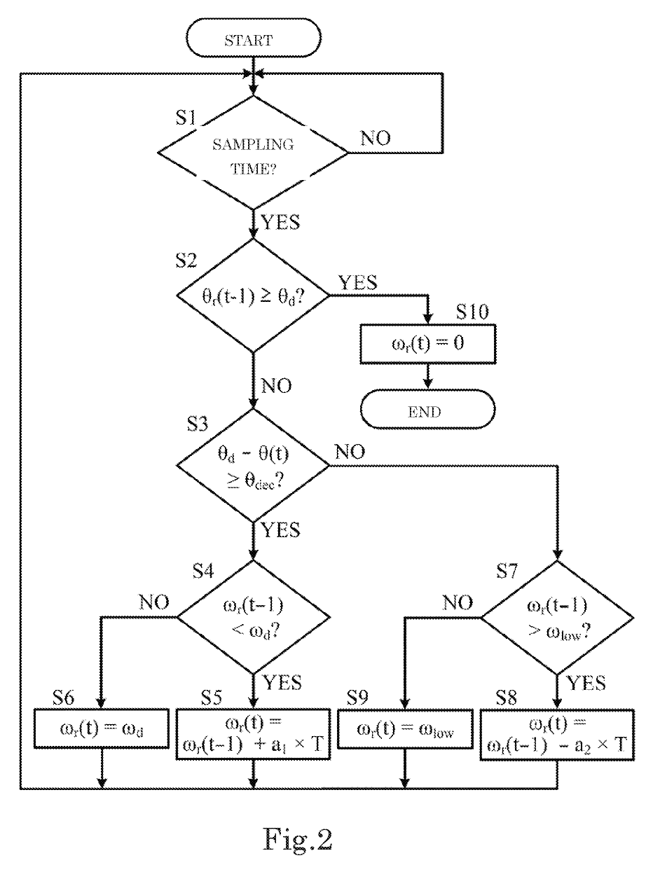

Determination processing for reference rotating speed according to the embodiment is explained with reference to FIG. 2.

At a sampling time (if the determination in step S1 is affirmative), the reference determining section 7 determines whether the immediately preceding reference angle position θᵣ (t−1) has reached the target angle position θ_{d} (step S2). Determination processing for a reference angle position (a command angle position) is explained below.

If the determination in step S2 is negative, the processing proceeds to step S3. In step S3, the reference determining section 7 determines whether the value obtained by subtracting the present actual angle position θ(t) from the target angle position θ_{d} is equal to or larger than the deceleration start border angle θ_{dec}.

If the determination in step S3 is affirmative, the processing proceeds to step S4. The reference determining section 7 determines whether the immediately preceding reference rotating speed ωᵣ(t−1) determined by the reference determining section 7 is lower than the target rotating speed ω_{d}.

If the determination in step S4 is affirmative, the processing proceeds to step S5. In step S5, the reference determining section 7 determines the present reference rotating speed ωᵣ(t) by adding a speed increment to the immediately preceding reference rotating speed ωᵣ(t−1) determined by the reference determining section 7. That is, when the immediately preceding rotating speed ωᵣ(t−1) of the motor 2 is lower than the target rotating speed ω_{d}, the reference determining section 7 determines to increase the present reference rotating speed ωᵣ(t) by adding a speed increment to the immediately preceding reference rotating speed ωᵣ(t−1) of the motor 2. The speed increment is a value obtained by multiplying the acceleration coefficient a₁ by the sampling period T.

In step S5, the reference determining section 7 supplies, as a command value for rotating the motor 2, the present reference rotating speed ωᵣ(t) determined by the reference determining section 7 to the motor controller 4. After step S5, the processing returns to step S1 and stays on standby until the next sampling time.

If the determination in step S4 is negative, the processing proceeds to step S6. In step S6, the reference determining section 7 determines the target rotating speed ω_{d} as the present reference rotating speed ωᵣ(t). That is, when the immediately preceding reference rotating speed ωᵣ(t−1) of the motor 2 determined by the reference determining section 7 is equal to or higher than the target rotating speed ω_{d}, the reference determining section 7 determines to maintain the target rotating speed ω_{d} as the present reference rotating speed ωᵣ(t).

In step S6, the reference determining section 7 supplies, as a command value for rotating the motor 2, the present reference rotating speed ωᵣ(t) determined by the reference determining section 7 to the motor controller 4. After step S6, the processing returns to step S1 and stays on standby until the next sampling time.

On the other hand, if the determination in step S3 is negative, the processing proceeds to step S7. That is, when the value obtained by subtracting the present actual angle position θ(t) from the target angle position θ_{d} is smaller than the deceleration start border angle θ_{dec}, the processing proceeds to step S7. In step S7, the reference determining section 7 determines whether the immediately preceding reference rotating speed ωᵣ(t−1) determined by the reference determining section 7 is higher than the low rotating speed ω_{low}.

If the determination in step S7 is affirmative, the processing proceeds to step S8. In step S8, the reference determining section 7 determines the present reference rotating speed ωᵣ(t) by subtracting a speed decrement from the immediately preceding reference rotating speed ωᵣ(t−1) determined by the reference determining section 7. That is, after the present actual angle position θ(t) reaches a predetermined deceleration start angle (the target angle position θ_{d}−θ_{dec}), when the immediately preceding reference rotating speed ωᵣ(t−1) is larger than the predetermined low rotating speed threshold ω_{low}, the reference determining section 7 determines to reduce the present reference rotating speed ωᵣ(t) by subtracting the speed decrement from the immediately preceding rotating speed ωᵣ(t−1). The speed decrement is a value obtained by multiplying the deceleration coefficient a₂ by the sampling period T.

In step S8, the reference determining section 7 supplies, as a command value for rotating the motor 2, the present reference rotating speed ωᵣ(t) determined by the reference determining section 7 to the motor controller 4. After step S8, the processing returns to step S1 and stays on standby until the next sampling time.

If the determination in step S7 is negative, the processing proceeds to step S9. In step S9, the reference determining section 7 determines the low rotating speed ω_{low} as the present reference rotating speed ωᵣ(t). That is, after the present actual angle position θ(t) reaches a predetermined deceleration start angle θ_{dec}, (when the immediately preceding reference rotating speed ωᵣ(t−1) is equal to or lower than the low rotating speed threshold ω_{low}, the reference determining section 7 determines to maintain the low rotating speed ω_{low} as the present reference rotating speed ωᵣ(t).

In step S9, the reference determining section 7 supplies, as a command value for rotating the motor 2, the present reference rotating speed ωᵣ(t) determined by the reference determining section 7 to the motor controller 4. After step S9, the processing returns to step S1 and stays on standby until the next sampling time.

On the other hand, if the determination in step S2 is affirmative, the processing proceeds to step S10. In step S10, the reference determining section 7 determines the present reference rotating speed ωᵣ(t) as zero. That is, after the immediately preceding reference angle position θᵣ(t−1) reaches the target angle position θ_{d} of the motor 2, the reference determining section 7 determines the present reference rotating speed ωᵣ(t) as zero.

In step S10, the reference determining section 7 supplies, as a command value for rotating the motor 2, the present reference rotating speed ωᵣ(t) determined by the reference determining section 7 to the motor controller 4. After step S10, the processing ends.

The operation of the motor 2 conforming to the determination processing for the reference rotating speed according to the embodiment includes five segments (stages) of acceleration, constant speed, deceleration, low speed rotation, and stop. The acceleration segment is executed by repetition of the operation proceeding to step S5 through steps S2, S3, and S4. In the acceleration segment, the rotating speed of the motor 2 continues to increase according to addition of a constant speed increment (a₁×T) to the immediately preceding reference rotating speed ωᵣ(t−1) of the motor 2 until the immediately preceding reference rotating speed ωᵣ(t−1) of the motor 2 reaches the target rotating speed ω_{d}.

The constant speed segment is executed according to repetition of the operation proceeding to step S6 through steps S2, S3, and S4 taking the opportunity that the immediately preceding reference rotating speed ωᵣ(t−1) reaches the target rotating speed ω_{d} (the determination in step S4 is negative). In the constant speed segment, the target rotating speed ω_{d} is maintained as the present reference rotating speed ωᵣ(t). The motor 2 continues to rotate at the constant speed ω_{d}.

The deceleration segment is executed according to repetition of the operation proceeding to step S8 through steps S2, S3, and S7 taking the opportunity that the present actual angle position θ(t) determined by the reference determining section 7 reaches the predetermined deceleration start angle (the determination in step S3 is negative). In the deceleration segment, the rotating speed of the motor 2 continues to decrease according to subtraction of a constant speed decrement (a₂×T) from the immediately preceding reference rotating speed ωᵣ(t−1) of the motor 2 until the immediately preceding reference rotating speed ωᵣ(t−1) of the motor 2 decreases to the low rotating speed ω_{low}.

The low speed rotation segment is executed according to repetition of the operation proceeding to step S9 through steps S2, S3, S7 taking the opportunity that, after the present actual angle position θ(t) determined by the reference determining section 7 reaches the predetermined deceleration start angle, the immediately preceding reference rotating speed ωᵣ(t−1) decreases to the low rotating speed ω_{low} (the determination in step S7 is negative). In the low speed rotation segment, the low rotating speed ω_{low} is maintained as the present reference rotating speed ωᵣ(t). The motor 2 continues to rotate at the constant low rotating speed ω_{low}.

The stop segment is executed according to the operation proceeding to step S10 taking the opportunity that the immediately preceding reference angle position θᵣ(t−1) determined by the reference determining section 7 reaches the target angle position θ_{d} of the motor 2 (the determination in step S2 is affirmative). In the stop segment, the present reference rotating speed ωᵣ(t) is determined as zero. The rotation of the motor 2 is stopped.

With the determination processing for the reference rotating speed according to the embodiment, it is possible to easily and dynamically determine the present reference rotating speed ωᵣ(t). Specifically, in the acceleration segment, it is possible to easily and dynamically determine the present reference rotating speed ωᵣ(t) from the immediately preceding reference rotating speed ωᵣ(t−1) and the predetermined acceleration coefficient a₁ (step S5). In the constant speed segment, it is possible to easily and dynamically determine the present reference rotating speed ωᵣ(t) from the target rotating speed ω_{d} (step S6). In the deceleration segment, it is possible to easily and dynamically determine the present reference rotating speed ωᵣ(t) from the immediately preceding reference rotating speed ωᵣ(t−1) and the predetermined deceleration coefficient a₂ (step S8). In the low speed rotation segment, it is possible to easily and dynamically determine the present reference rotating speed ωᵣ(t) from the low rotating speed ω_{low} (step S9).

With the determination processing for the reference rotating speed according to the embodiment, it is possible to easily and dynamically determine the present reference rotating speed ωᵣ(t) from given parameters and/or given variables according to a predetermined state.

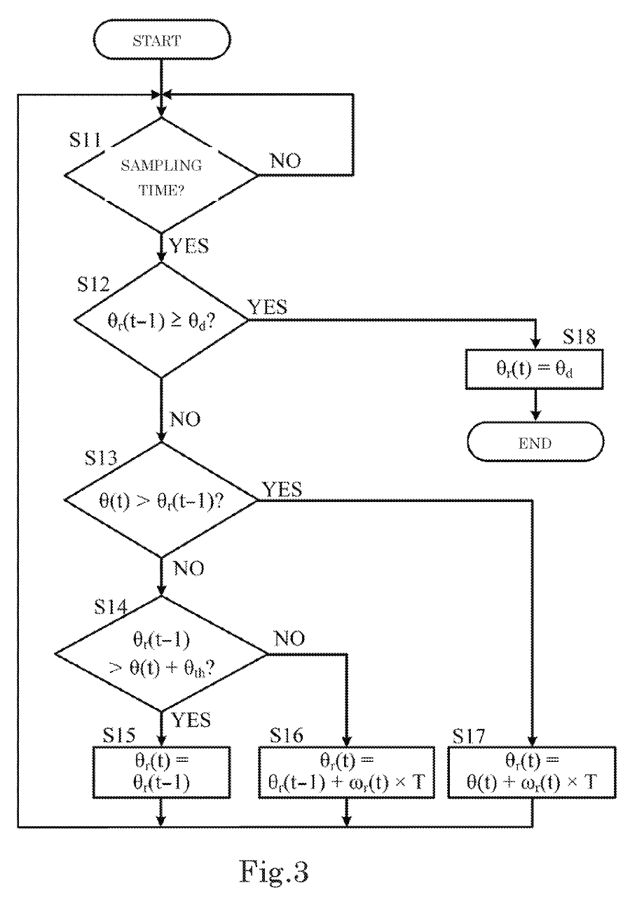

Determination processing for a reference angle position (a command angle position) according to the embodiment is explained with reference to FIG. 3. The determination processing for the reference angle position is executed in parallel to the determination processing for the reference rotating speed. More accurately, the determination processing for the reference angle position is started later than the determination processing for the reference rotating speed.

At a sampling time (if the determination in step S11 is affirmative), the reference determining section 7 determines whether the immediately preceding reference angle position ωᵣ(t−1) determined by the reference determining section 7 has reached the target angle position θ_{d} of the motor 2 (step S12). If the determination in step S12 is negative, the processing proceeds to step S13. In step S13, the reference determining section 7 determines whether the present actual angle position θ(t) of the motor 2 acquired from the rotary encoder unit 12 is larger than the immediately preceding reference angle position θᵣ(t−1) determined by the reference determining section 7. That is, in step S13, the reference determining section 7 determines whether the present actual angle position θ(t) is ahead of the immediately preceding reference angle position θᵣ(t−1) determined by the reference determining section 7.

If the determination in step S13 is negative, the processing proceeds to step S14. In step S14, the reference determining section 7 determines whether the immediately preceding reference angle position θᵣ(t−1) is larger than a value obtained by adding the position delay threshold θₜₕ to the present actual angle position θ(t). That is, in step S14, the reference determining section 7 determines whether the position error θₑ is larger than the position delay threshold θₜₕ.

If the determination in step S14 is affirmative, the processing proceeds to step S15. In step S15, the reference determining section 7 determines the immediately preceding reference angle position θᵣ(t−1) as the present reference angle position θᵣ(t). That is, when the present actual angle position θ(t) is delayed behind the immediately preceding reference angle position θᵣ(t−1) and a delay amount (the position error θₑ) is larger than the threshold θₜₕ, the reference determining section 7 determines the immediately preceding reference angle position θᵣ(t−1) as the present reference angle position θᵣ(t).

In step S15, the reference determining section 7 supplies, as a command value for rotating the motor 2, the present reference angle position (the present command angle position) θᵣ(t) determined by the reference determining section 7 to the motor controller 4. After step S15, the processing returns to step S11 and stays on standby until the next sampling time.

On the other hand, if the determination in step S14 is negative, the processing proceeds to step S16. In step S16, the reference determining section 7 determines the present reference angle position θᵣ(t) by adding an angle increment corresponding to the rotating speed of the motor 2 to the immediately preceding reference angle position θᵣ(t−1). That is, when the present actual angle position θ(t) coincides with the immediately preceding reference angle position θᵣ(t−1) or the present actual angle position θ(t) is delayed behind the immediately preceding reference angle position θᵣ(t−1) but the delay amount (the position error θₑ) is equal to or smaller than the threshold θₜₕ, the reference determining section 7 determines the present reference angle position θᵣ(t) by adding the angle increment to the immediately preceding reference angle position θᵣ(t−1). The angle increment is, for example, a value obtained by multiplying the present reference rotating speed ωᵣ(t), which is determined by the determination processing for the reference rotating speed, by the sampling period T. However, the angle increment may be a value obtained by multiplying the present actual angle position θ(t) by the sampling period T.

In step S16, the reference determining section 7 supplies, as a command value for rotating the motor 2, the present reference angle position (the present command angle position) θᵣ(t) determined by the reference determining section 7 to the motor controller 4.

On the other hand, if the determination in step S13 is affirmative, the processing proceeds to step S17. In step S17, the reference determining section 7 determines the present reference angle position θᵣ(t) by adding an angle increment to the present actual angle position θ(t). That is, when the present actual angle position θ(t) of the motor 2 is ahead of the immediately preceding reference angle position θᵣ(t−1), the reference determining section 7 determines the present reference angle position θᵣ(t) by adding the angle increment to the present actual angle position θ(t). The angle increment is, for example, a value obtained by multiplying the present reference rotating speed ωᵣ(t), which is determined by the determination processing for the reference rotating speed, by the sampling period T. However, the angle increment may be a value obtained by multiplying the present actual angle position θ(t) by the sampling period T.

In step S17, the reference determining section 7 supplies, as a command value for rotating the motor 2, the present reference angle position (the present command angle position) θᵣ(t) determined by the reference determining section 7 to the motor controller 4. After step S17, the processing returns to step S11 and stays on standby until the next sampling time.

If the determination in step S12 is affirmative, the processing proceeds to step S18. In step S18, the reference determining section 7 determines the target angle position θ_{d} as the present reference angle position θᵣ(t). That is, when the immediately preceding reference angle position θᵣ(t−1) has reached the target angle position θ_{d} of the motor 2, the reference determining section 7 determines the target angle position θ_{d} as the present reference angle position θᵣ(t).

In step S18, the reference determining section 7 supplies, as a command value for rotating the motor 2, the present reference angle position (the present command angle position) θᵣ(t) determined by the reference determining section 7 to the motor controller 4. After step S18, the processing ends.

With the determination processing for the reference angle position according to the embodiment, even if disturbance or a change in a load applied to the motor 2 occurs, the motor 2 is operated without being suddenly accelerated or decelerated. Therefore, it is possible to minimize an overshoot and reduce a setting time. It is possible to improve the life of components of the motor 2 and components related to the motor 2.

Specifically, when the present actual angle position θ(t) is delayed behind the immediately preceding reference angle position θᵣ(t−1) and the delay amount (the position error θₑ) is larger than the threshold θₜₕ, the reference determining section 7 determines the immediately preceding reference angle position θᵣ(t−1) as the present reference angle position θᵣ(t) (step S15). In other words, the reference angle position does not increase until the delay amount (the position error θₑ) decreases to the threshold θₜₕ or less. In this case, it is possible to always maintain the position error θₑ at the threshold θₜₕ or less. Therefore, it is possible to avoid or reduce saturation of a driving signal supplied from the motor controller 4 to the motor 2. It is possible to minimize an overshoot and reduce a setting time.

When the present actual angle position θ(t) coincides with the immediately preceding reference angle position θᵣ(t−1) or the present actual angle position θ(t) is delayed behind the immediately preceding reference angle position θᵣ(t−1) but the delay amount (the position error θₑ) is equal to or smaller than the threshold θₜₕ, the reference determining section 7 determines the present reference angle position θᵣ(t) by adding the angle increment to the immediately preceding reference angle position θᵣ(t−1) (step S16). In this case, it is conceivable that the actual angle position θ(t) can follow the reference angle position. By adding the angle increment to the immediately preceding reference angle position θᵣ(t−1), the present reference position θᵣ(t) is updated. Therefore, the reference angle position gradually increases toward the target angle position θ_{d}.

When the present actual angle position θ(t) of the motor 2 is ahead of the immediately preceding reference angle position θᵣ(t−1), the reference determining section 7 determines the present reference angle position θᵣ(t) by adding the angle increment to the present actual angle position θ(t) (step S17). In this case, the reference determining section 7 determines the present reference angle position θᵣ(t) simply by adding the angle increment to the present actual angle position θ(t). Therefore, the motor 2 is not suddenly decelerated. It is possible to easily determine the present reference angle position θᵣ(t) simply by adding the angle increment to the present actual angle position θ(t).

The angle increment used in steps S16 and S17 is, for example, a value obtained by multiplying the present reference rotating speed ωᵣ(t), which is determined by the determination processing for the reference rotating speed, by the sampling period T. However, the angle increment may be a value obtained by multiplying the present actual angle position θ(t) by the sampling period T. In any case, the angle increment can be easily calculated. In steps S16 and S17, it is possible to easily determine the present reference angle position θᵣ(t) from the angle increment.

The embodiment of the present disclosure is explained above. However, the above explanation does not limit the present disclosure. Various modifications including deletion, addition, and substitution of the constituent elements are conceivable in the technical scope of the present disclosure.

For example, the control device 1 according to the embodiment is provided in a mobile robot in order to control the motor 2 that rotates a wheel of the mobile robot. However, the present disclosure may be used for control of a motor of an articulated robot, a vehicle, or a conveying apparatus. A machine element driven by the motor 2 is not limited to the wheel and may be an arm of the articulated robot, a roller of the conveying apparatus, or other machine elements.

In the control device 1 or the motor controller 4, functions executed by the processor may be executed by hardware instead of the processor or may be executed by a programmable logic device such as an FPGA (Field Programmable Gate Array) or a DSP (Digital Signal Processor).

In the embodiment, the rotary encoder unit 12 derives the present actual angle position θ(t) of the motor 2 and supplies an angle position signal indicating the angle position θ(t) to the motor controller 4, the reference determining section 7, and the speed calculating section 10. However, the speed calculating section 10 may calculate, based on an angle position signal from an angle sensor of another type, the present actual angle position θ(t) and the present actual rotating speed ω(t) of the motor 2.

The acceleration coefficient a₁ used in step S5 of the determination processing for the reference rotating speed (FIG. 2) is a fixed value in the embodiment. However, the acceleration coefficient a₁ may be a variable value that changes according to rotating speed of the motor 2. For example, the acceleration coefficient a₁ may be reduced when the rotating speed of the motor 2 approaches the target rotating speed ω_{d}.

The deceleration coefficient a₂ used in step S8 of the determination processing for the reference rotating speed (FIG. 2) is a fixed value in the embodiment. However, the deceleration coefficient a₂ may be a variable value that changes according to the rotating speed of the motor 2. However, the deceleration coefficient a₂ may be reduced when the rotating speed of the motor 2 approaches the low rotating speed ω_{low}.

The low rotating speed ω_{low} used in step S9 of the determination processing for the reference rotating speed (FIG. 2) is a fixed value in the embodiment. However, the low rotating speed ω_{low} may be a variable value that changes according to an angle position of the motor 2. In this case, the low rotating speed ω_{low} used as the speed reference in step S9 may be different from the low rotating speed ω_{low} used as the threshold in step S7. For example, the low rotating speed ω_{low} used as the speed reference in step S9 may be reduced when the angle position of the motor 2 approaches the target angle position θ_{d}.

A sign “>” in step S14 of the determination processing for the reference angle position (FIG. 3) may be replaced with “≥”. That is, when the delay amount (the position error θₑ) is equal to the threshold θₜₕ, the processing proceeds to step S16 in the embodiment. However, in this case, the processing may proceed to step S15.

Items related to other aspects of the present disclosure are enumerated below.

1. A control device for a motor, the control device including a reference determining section configured to acquire an actual rotation angle of the motor at a predetermined period and determine, at the predetermined period, a reference rotation angle of the motor as a command value for rotating the motor, in which when the actual rotation angle of the motor is ahead of an immediately preceding reference rotation angle determined by the reference determining section, the reference determining section determines a present reference rotation angle by adding an angle increment to the actual rotation angle.

2. The control device for the motor described in the item 1, in which, when the immediately preceding reference rotation angle reaches a target rotation angle of the motor, the reference determining section determines the target rotation angle as the present reference rotation angle.

3. A control device for a motor, the control device including a reference determining section configured to determine, as a command value for rotating the motor, reference rotating speed of the motor at a predetermined period, in which when immediately preceding reference rotating speed of the motor determined by the reference determining section is lower than target rotating speed, the reference determining section determines present reference rotating speed by adding a speed increment to the immediately preceding reference rotating speed of the motor, and when the immediately preceding reference rotating speed is equal to or higher than the target rotating speed, the reference determining section determines the target rotating speed as the present reference rotating speed.

4. The control device for the motor described in the item 3, in which after an actual rotation angle of the motor reaches a predetermined deceleration start angle, when the immediately preceding reference rotating speed determined by the reference determining section is larger than a predetermined low rotating speed threshold, the reference determining section determines the present reference rotating speed by subtracting a speed decrement from the immediately preceding reference rotating speed, and after the actual rotation angle reaches the predetermined deceleration start angle, when the immediately preceding reference rotating speed is equal to or smaller than the low rotating speed threshold, the reference determining section determines low rotating speed as the present reference rotating speed.

5. The control device for the motor described in the item 3 or 4, in which the reference determining section determines the present reference rotating speed as zero after the immediately preceding reference rotation angle reaches a target rotation angle of the motor.

6. A robot including: at least one motor; the control device described in any one of the items 1 to 5 accompanying the at least one motor; and a machine element driven by the at least one motor.

7. A control method for a motor, the control method including: acquiring an actual rotation angle of the motor at a predetermined period; and determining, at the predetermined period, a reference rotation angle of the motor as a command value for rotating the motor, in which in the determining the reference rotation angle, when the actual rotation angle of the motor is ahead of an already determined immediately preceding reference rotation angle, a present reference rotation angle is determined by adding an angle increment to the actual rotation angle.

8. A control method for a motor, the control method including determining, at a predetermined period, reference rotating speed of the motor as a command value for rotating the motor, in which in the determining the reference rotating speed, when already determined immediately preceding reference rotating speed of the motor is lower than target rotating speed, present reference rotating speed is determined by adding a speed increment to the immediately preceding reference rotating speed of the motor, and when the immediately preceding reference rotating speed is equal to or higher than the target rotating speed, the target rotating speed is determined as the present reference rotating speed.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A control device for a motor, the control device being configured or programmed to include a reference determiner to acquire an actual rotation angle of the motor at a predetermined period and determine, at the predetermined period, a reference rotation angle of the motor as a command value to rotate the motor; wherein
when the actual rotation angle of the motor is delayed behind an immediately preceding reference rotation angle determined by the reference determiner and a delay amount is smaller than a predetermined threshold, the reference determiner determines a present reference rotation angle by adding an angle increment corresponding to a rotating speed of the motor to the immediately preceding reference rotation angle; and
when the actual rotation angle is delayed behind the immediately preceding reference rotation angle and the delay amount is larger than the threshold, the reference determiner determines the immediately preceding reference rotation angle as the present reference rotation angle.

2. The control device for the motor according to claim 1, wherein, when the actual rotation angle of the motor is ahead of the immediately preceding reference rotation angle, the reference determiner determines the present reference rotation angle by adding the angle increment to the actual rotation angle.

3. The control device for the motor according to claim 1, wherein, when the immediately preceding reference rotation angle reaches a target rotation angle of the motor, the reference determiner determines the target rotation angle as the present reference rotation angle.

4. The control device for the motor according to claim 1, wherein
the reference determiner determines, at the predetermined period, a reference rotating speed of the motor as a command value to rotate the motor; and
the angle increment is obtained by multiplying a present reference rotating speed, which is determined by the reference determiner, by the predetermined period.

5. The control device for the motor according to claim 1, wherein
the reference determiner determines, at the predetermined period, a reference rotating speed of the motor as a command value to rotate the motor;
when immediately preceding reference rotating speed of the motor determined by the reference determiner is lower than target rotating speed, the reference determiner determines a present reference rotating speed by adding a speed increment to the immediately preceding reference rotating speed of the motor; and
when the immediately preceding reference rotating speed is equal to or higher than the target rotating speed, the reference determiner determines the target rotating speed as the present reference rotating speed.

6. The control device for the motor according to claim 5, wherein
after the actual rotation angle reaches a predetermined deceleration start angle, when the immediately preceding reference rotating speed determined by the reference determiner is larger than a predetermined low rotating speed threshold, the reference determiner determines the present reference rotating speed by subtracting a speed decrement from the immediately preceding reference rotating speed; and
after the actual rotation angle reaches the predetermined deceleration start angle, when the immediately preceding reference rotating speed is equal to or smaller than the low rotating speed threshold, the reference determiner determines a low rotating speed as the present reference rotating speed.

7. The control device for the motor according to claim 5, wherein the reference determiner determines the present reference rotating speed as zero after the immediately preceding reference rotation angle reaches a target rotation angle of the motor.

8. The control device for the motor according to claim 4, wherein the reference determiner outputs, as a command value to rotate the motor, the present reference rotating speed determined by the reference determiner.

9. The control device for the motor according to claim 1, wherein the reference determiner outputs, as a command value to rotate the motor, the present reference rotation angle determined by the reference determiner.

10. A robot comprising:
at least one motor;
the control device according to claim 1 accompanying the at least one motor; and
a machine element driven by the at least one motor.

11. A control method for a motor comprising:
acquiring an actual rotation angle of the motor at a predetermined period; and
determining, at the predetermined period, a reference rotation angle of the motor as a command value to rotate the motor; wherein
in the determining the reference rotation angle:
when the actual rotation angle of the motor is delayed behind an already determined immediately preceding reference rotation angle and a delay amount is smaller than a predetermined threshold, a present reference rotation angle is determined by adding an angle increment corresponding to a rotating speed of the motor to the immediately preceding reference rotation angle; and
when the actual rotation angle is delayed behind the immediately preceding reference rotation angle and the delay amount is larger than the threshold, the immediately preceding reference rotation angle is determined as the present reference rotation angle.
